(19) United States
(12) Patent Application Publication
(10) Pub. No.: US 2025/0100031 A1
(43) Pub. Date: Mar. 27, 2025

(54) A MECHANICAL CAPSULE SEPARATING SYSTEM FOR COMMERCIAL USE

(71) Applicant: WHITE STAR S.R.L., Roma (IT)

(72) Inventors: Stefano CECCARELLI, Rieti (RI) (IT); Paolo COSTANTINI, Umm Suqeim Second, DUBAI (AE)

(21) Appl. No.: 18/291,028

(22) PCT Filed: Jul. 21, 2022
(86) PCT No.: PCT/IB2022/056758

§ 371 Date: Jan. 22, 2024

(30) Foreign Application Priority Data
Jul. 23, 2021 (IT) 102021000019628

(51) Int. Cl. B09B 3/35; B09B 101/02; B09B 101/70

(52) U.S. Cl. CPC B09B 3/35; B09B 2101/02; B09B 2101/70

(57) ABSTRACT

An apparatus tears, breaks or divides into several parts the casing of capsules and/or pods containing coffee or other infusions, which allows the organic part contained therein to be separated from the recyclable part, consisting of the casing made of aluminum or plastic. The apparatus includes a perforated basket directly connected to a pipe arranged at the top, for feeding the empty pods or capsules, conforming the geometry of the system to eliminate the feeding pipe arranged by the side (which was subject to constant dirtying by the organic contents subjected to centrifugal force). The basket contains a tearing unit and has at least one opening at the top, the size and shape of which adjust the stay time of the capsules in the perforated basket or separation compartment. A cleaning unit cleans externally the perforated basket from the residues, which obstruct the side holes of the perforated basket.

### CROSS-REFERENCE TO RELATED APPLICATIONS

This application is the US national stage of PCT/IB2022/056758 filed Jul. 21, 2022 and designating the United States, which claims the priority of IT 102021000019628 filed Jul. 23, 2021. The entire contents of each foregoing application are incorporated herein by reference.

### BACKGROUND OF THE INVENTION

### Field of the Invention

The present invention relates to the field of electrical apparatuses, and in particular is directed to an apparatus adapted to tear, break or divide, into several parts, the casing of capsules and/or pods containing coffee or other infusions, which allows the organic part contained therein (which is compostable) to be separated from the recyclable part, consisting of the casing (i.e., the body of the pod or capsule, containing the organic part) made of aluminum or plastic.

### Description of the Related Art

Devices are known for separating the organic material contained in used pods and/or capsules from the rest of the casing, but one common problem of such apparatuses is that such a separation is not complete and therefore the treated casings are not completely devoid of the original organic contents thereof, and vice versa. This prevents the disposal thereof as recyclable differentiated waste, substantially impeding the processing of the empty capsules/pods, which is carried out by means of said known apparatuses. The current alternative would be to subject the treated capsules/pods to further processing, to eliminate the residual organic material from the casings, with evident additional costs.

Furthermore, apparatuses are also known, which, similarly to the invention, allows pods or capsules to be torn and separated from the organic contents contained therein.

In these known apparatuses, the pods or capsules are torn and subjected to an energetic movement and shaking, allowing the organic part to exit from the casing, favoring the separation thereof, mainly by centrifugal force.

A first problem of said known apparatuses is the frequent dirtying/obstruction of the feeding pipe, which allows the empty pods or capsules to reach the separation zone; this pipe usually connects the loading zone with the side zone of the separation basket.

The dirtying, inevitable with such a lateral inlet position of the capsules/pods, is mainly due to the fact that the organic contents (almost always damp), released from the pods or capsules because of the movement thereof, has the feature of sticking to any surface they come into contact with, and this results in a variety of problems. In this specific case of the aforesaid known apparatuses, the capsules and/or pods slide inside the pipe by gravity, and in the lower part facing the separation compartment, the useful size of the pipe is reduced because of the damp coffee powder sticking to the walls. For such a reason, said capsules and/or pods block in the pipe and therefore it is necessary to intervene manually to free it from the capsules/pods and clean the surfaces, the pipe being not easy to reach and almost impossible to clean thoroughly due to the shape thereof. Similar problems are displayed between the exterior of the separation compartment (with the side surface perforated, from which the organic part exits) and the containment walls thereof: the organic residues of coffee, tea, etc. tend to stick outside the holes, quickly obstructing such holes on the outer side.

Basically, the dirtying of the inlet pipe and the outlet holes is due to the organic contents of the is empty pods/capsules, which the main cause of malfunctioning of the whole apparatus, also jeopardizing the quality of the resulting materials. Such organic contents, in combination with a varying degree of humidity, tend to stick everywhere and therefore, if there are no means adapted to clean such surfaces, the apparatus will block continuously. In this case, with every machine stop, it will constantly be necessary to intervene manually and clean the various pipes and surfaces, but with poor results due to the difficulty of access.

As a result, even by carrying out a frequent clean to avoid obstructions, which would result in machine malfunctioning, such known apparatuses have poor efficiency and the resulting products (torn and empty casings—organic contents) are not perfectly suitable for the respective recycling-composting thereof.

A second problem actually relates to the level of separation between the organic part and the recyclable part obtainable from this known apparatuses: contamination by the recyclable fraction is common in the organic fraction, or vice versa. This involves the need for further treatments, especially of the organic part, in order to obtain an uncontaminated matrix which is thus environmentally-friendly and usable for different purposes.

In order to obtain the two resulting materials of which the pods/capsules are made with as little contamination as possible, the separation system must work so that both the feeding flow and the outlet flows (of the two components) must be regulated taking into account at least four variables, which are:
the different shapes and sizes of the casing;
the materials forming the casing: aluminum, plastic, plastic/aluminum;
the level of humidity of the organic material; and
The time elapsed from use to insertion and the separation system, i.e., the level of deterioration/modification, of the organic part.

Such an adjustment must preferably be carried out experimentally.

### SUMMARY OF THE INVENTION

It is an object of the invention to overcome the aforesaid problems by providing a mechanical system comprising an apparatus which allows separating the organic part and the recyclable part of all the capsules or pods used, currently available on the market.

It is another object of the invention to manufacture an apparatus provided with alternative pipes in order to avoid dirtying them, creating a fair compromise in relation to all the aforesaid variables.

It is a third object to provide a system provided with safe, efficient and practical mechanical means for cleaning the organic residues.

It is a fourth object to manufacture an apparatus provided with controlled feeding means for feeding the empty capsules/pods.

It is a fifth object to optimize the functionality and efficiency of the apparatus, minimizing the reciprocal contamination between the two separated parts (compostable organic and recyclable casing).

It is a further object to manufacture a separator unit having the feature of giving the same results even modifying the sizes, creating a fair ratio of the diameter of the perforated basket (or separation compartment) to the height thereof, providing for an upper outlet opening or upper/side opening, which will be dimensioned and obtained according to the desired result.

It is understood that the tearing and movement system (the shaft with the related “blades”) must also be dimensioned accordingly. By varying the feeding speed and the number of turns of the tearing system, the various combinations described above can give different results in terms of efficiency.

This was achieved, according to the present invention, by providing a system provided with an apparatus including a perforated basket directly connected to a pipe arranged at the top, for feeding the empty pods or capsules, conforming the geometry of the system so as to eliminate the feeding pipe arranged by the side (which was subjected to constant dirtying by the organic part subjected to centrifugal force). Said basket containing means for tearing the capsules/pods and being provided with at least one upper opening, the size and shape of which are configured to adjust the stay time of the capsules in the perforated basket or separation compartment.

Another particular feature of the invention relates to the fact of providing mechanical means adapted to externally clean the perforated basket from the residues of coffee, or other compostable organic contents, blocking the side holes of said perforated basket.

A better understanding of the invention will be had by means of the following detailed description and with reference to the accompanying figures, illustrating preferred embodiments by way of non-limiting examples.

### BRIEF DESCRIPTION OF THE DRAWINGS

In the drawings:

FIG. 1 shows a vertical section of the invention with overlapping resulting containers.

FIG. 2 shows a vertical section of the invention, on the left, in a version extending in height, with overlapping resulting containers; a door is outlined on the right side with see-through parts in order to show: the separation unit, the door (3) with loading slide, a control display (25′), a see-through slot (16′) for viewing the capsules being processed inside, by means of a mirror (16), the separation unit and the resulting containers (10) and (11). This valorizes all the machinery because the client/user directly sees how the capsules or pods thereof are separated into two products (compostable organic part and recyclable casing), ready to be disposed of in a differentiated manner for successive composting and recycling, respectively. It is also possible to use see-through containers and one or more mirrors for increasing the visibility of the inserted capsules/pods and resulting products.

FIG. 3 shows a section of a second embodiment of the invention, the configuration of which is extended in width, with top loading and resulting containers set side-by-side.

FIG. 4 shows a third embodiment of the invention, with resulting containers set side-by-side and loading hopper with conveyor belt, in which the empty capsules are conveyed in a controlled manner directly into the feeding pipe.

FIG. 5 shows a unit consisting of the loading hopper, the selector and the separation compartment according to the invention.

FIG. 6a is a section according to the trace plane A-A indicated in FIG. 5.

FIG. 6b shows the mechanical means for cleaning the outer surface of the perforated basket from which the coffee (or other organic content) originally present in the capsules/pods exits.

FIG. 6c is a section according to the trace plane A-A indicated in FIG. 5 in which the three possible outlets U1, U2, U3 are visible.

FIG. 6d is a detail of the three possible outlets U1, U2, U3.

FIG. 7 shows the blade shaft (4) for tearing the capsules/pods.

FIG. 8 shows the perforated cylindrical basket or separation compartment (8), and a detail of the holes, preferably eyelet holes and the feeding pipe (6) directly connected on the upper part of the perforated cylindrical basket, which, together with the blade shaft, form the main and structural part of the separation system, including the initial part of the pipe, which acts as a connection between the selector (21) and the pipe (6).

FIG. 9 shows an exploded view of the components belonging to the means for controlled loading, tearing and separation, as well as cleaning according to the invention.

FIG. 10a is a perspective view of the separation compartment of the invention.

FIG. 10b is an exploded view of the outlet compartment of the capsules relative to FIG. 10a.

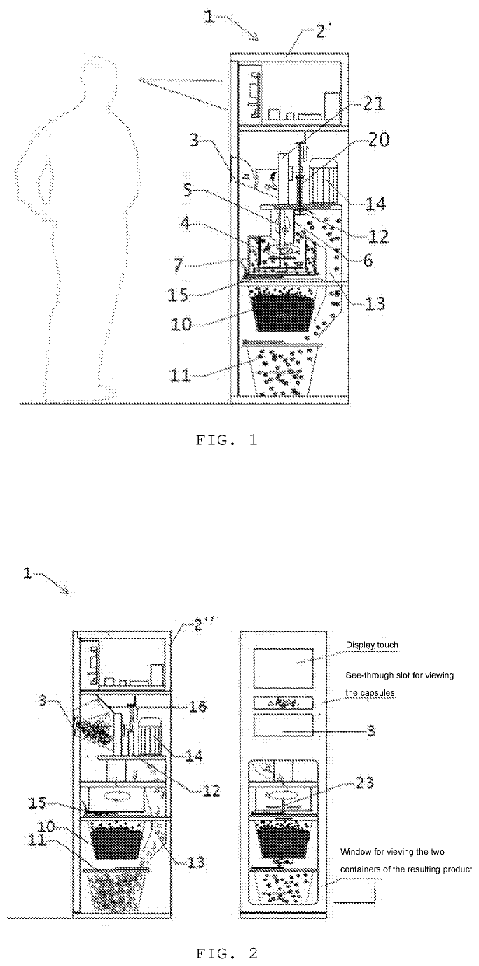

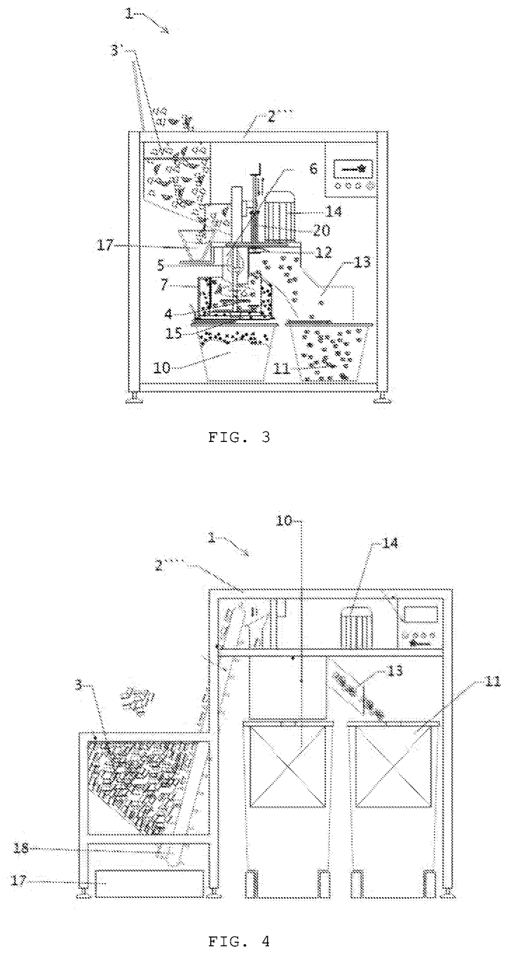

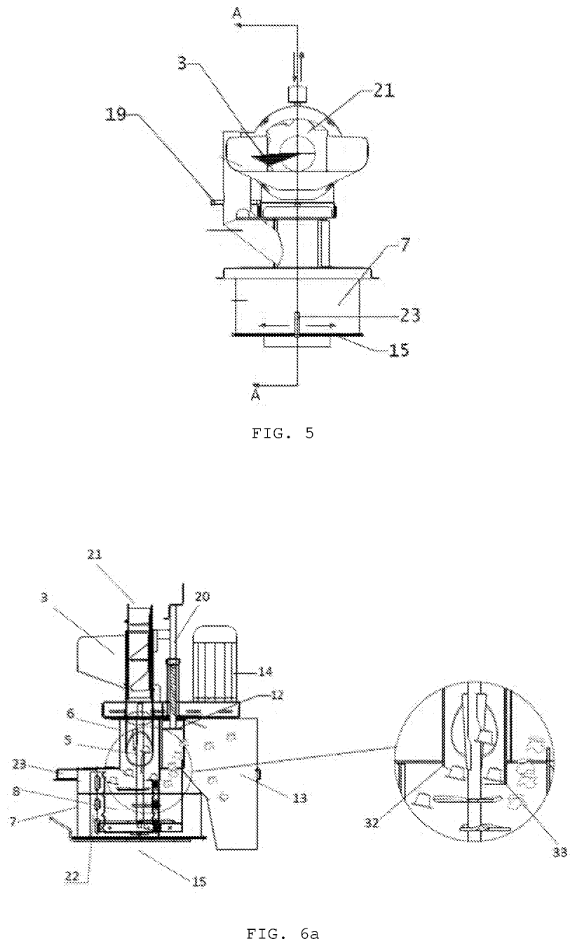

### DETAILED DESCRIPTION

According to the invention, the apparatus is installable directly where the capsules are used, sold and stocked, for domestic use, vending sector, Ho. Re. Ca sector, directly inside retailers and shops specializing in the sale of coffee capsules and in industrial applications, etc.

In a preferred, but non-limiting embodiment, said mechanical system separates capsules for commercial use and comprises an apparatus (1) including, in combination:
a load-bearing structure (2), with one of more doors for accessing the interior.
means (3) for loading and conveying the capsules and/or pods in a controlled manner inside the separation compartment (8), by means of a selector unit (21);
said selector unit (21) being motorized and provided with a selector wheel with shaped flights;
mechanical means (4) arranged in said separation compartment (8) adapted to tear, break or divide the casing of said capsules/pods and thus separate the compostable organic contents present in the capsules (coffee or infusion) from the recyclable materials forming the casing;
an upper inlet pipe (6), which allows the used capsules to directly enter the separation compartment (8);
means (15) for conveying the organic material exited from the treated capsules to the special collection container (10);
a first container (10) adapted to receive the organic waste, consisting of the compostable contents of the capsule (coffee or other infusion) separated from the casing;
a second container (11) adapted to receive the recyclable waste consisting of the remains of the casing of the capsule separated from the organic material;
   said mechanical system is further provided with manually-operated or motor-driven mechanical rotary cleaning means (22), adapted to scrape the outer walls of the compartment (8) for cleaning from the organic residue relative to the contents of the capsules/pods.

In a preferred, but non-limiting embodiment, the empty capsules or pods are loaded onto a conveyor slide (3), which directs them towards a selector unit (21).

Said selector unit (21) is motorized and consists of a selector wheel provided with partitions, or “flights”, the function of which is to take a single capsule from the conveyor slide and direct it towards the opening of the inlet pipe of the capsules (6); advantageously, the presence of said selector unit has the function of regulating the flow of the capsules inside the separator, based on the rotation speed of the wheel on which the “flights” are placed, avoiding obstructions of the loading pipe.

Furthermore, the selector wheel has the feature of having flights shaped with the side, or face, inclined; this results in a reduction of the gripping surface so as to carry only one “large” capsule and disadvantage the carrying of several small capsules, causing them to turn over on themselves and thus, carrying one thereof and discharging them into the feeding pipe one after another, then having them intercepted and counted by means of a photocell (19).

Said selector unit is preferably, but not exclusively, positioned above the perforated basket or separation compartment (8), thus allowing direct access of each empty capsule/pod from the selector unit (21) towards said inlet pipe (6) simply by gravity.

Advantageously, the connection pipe (6) placed between the selector unit (21) and the separation compartment (8) formed by a perforated basket, is substantially cylinder shaped. One feature of such a separation compartment (8), consists of the fact that at the upper outlet (U1, U2, U3) for the casings of the separated capsules, there is a channeling pipe for channeling said casings towards the discharge pipe (13) in the collection container (11).

The side of the outlet opening of the recyclable casings facing the discharge pipe (13) can be: raised (U1), or only laterally open (U2), or open both upwards and laterally (U3).

If said side of the outlet section is raised (U1), it substantially acts as a partial barrier for the casings during separation: in essence, this contrivance is such as to prevent the capsules or pods, falling through the pipe (6), from exiting from the outlet without stopping for a sufficiently long time in the separation compartment (8) and therefore being partially or completely intact at the outlet.

Furthermore, according to the invention, a cleaning plate (12) is provided, connected to the end of the plunger (20); said cleaning plate is conveniently shaped according to the outlets (U1, U2, U3) with which it must cooperate.

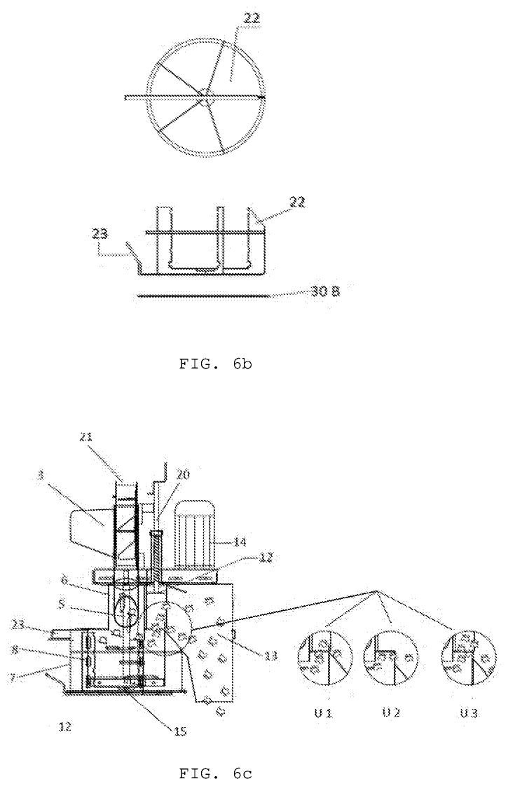

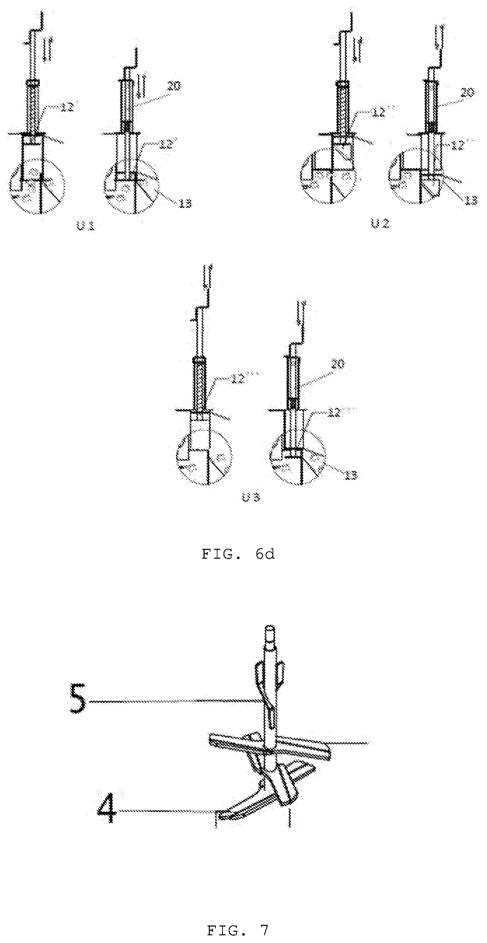

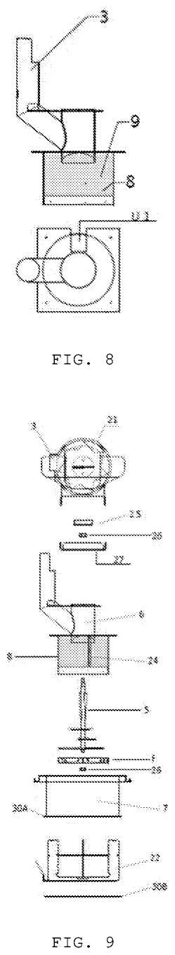

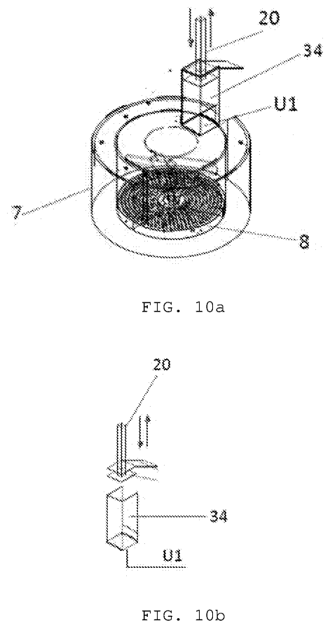

In detail, considering a raised outlet pipe (U1), a cleaning plate (12′) will be used, the function of which is to clean only the top outlet compartment (34); considering instead a laterally open outlet pipe (U2), the cleaning plate (12′') is of the shaped type for cleaning the zone of the pipe (13) at said side outlet; finally, for an outlet pipe which is open both upwards and laterally (U3), the cleaning plate (12′″) is conveniently shaped to clean both the top outlet compartment (34) and the part of the pipe (13) at said side outlet, as shown in FIG. 6d.

According to the invention, the separation compartment (8), also referred to as “perforated basket”, adapted to receive and tear the capsules, has a larger diameter than the upper inlet pipe (6); said compartment is closed at the bottom by a perforated and removable bottom (F), for inserting/removing the shaft provided with rotating blades (4). Said bottom (F) is preferably fixable with screws.

The separation unit includes a containment compartment (7), which contains the perforated basket (8) and collects the organic part exiting from the basket, it has a side surface for containing the powders, and is in communication with the first container (10) for collecting the compostable organic waste separated from the capsules/pods. Furthermore, by virtue of two rings: a fixed one (30A) which is integral with the lower end of the side surface of the containment compartment (7), and a removable one (30B) (FIG. 9), it is advantageously possible to provide said rotary cleaning system (22) for “scraping” the inner surface of said side surface and simultaneously the outer surface of the perforated basket (8), as well as the exterior of the removable bottom (F).

The upper section of said compartment is in communication with the inlet pipe (6) culminating inside the perforated basket (8) itself; furthermore, on the upper part of said containment compartment (7) of the basket (8), there is provided said outlet opening (U1, U2, U3) of the recyclable casings adapted to put said containment compartment (7) in communication with the second container (11) for collecting the remains of the casing of the capsules, by means of a discharge pipe (13).

In brief, in a preferred, but non-limiting embodiment, of the invention described thus far, said compartment (7) contains a glass-shaped perforated basket (8)—adapted to receive and treat the capsules—which is provided with holes (9), preferably eyelet holes, arranged over the whole side and bottom surface, and which is devoid of the upper surface.

Said means adapted to tear the casing of the capsules are placed in the perforated basket (8), described above, and substantially consist of a rotating shaft provided with blades (4), similar to the kitchen cutter shredder system. Said blades are preferably three in number, a scraper blade placed on the lower part of the shaft, an intermediate blade and an upper blade, respectively. The lower scraper “blade” is configured to keep the bottom clean, by favoring the upward movement of the casing or the parts forming it. Also by virtue of the centrifugal force generated by the rotation of the blades (4), the casing will meet the intermediate and upper blades, favoring the outlet thereof from the upper window (U1, U2, U3) at the same speed at which it rotates. The “blades” have an inclination with respect to the plane such as to generate an airflow, which favors the elevation of the casings of the capsules as they gradually become lighter due to the separation from the compostable organic contents thereof.

Furthermore, the part of the shaft above the upper blade is provided with conveniently shaped fins (5) for constantly keeping the feeding pipe (6) of the capsules free.

Advantageously, the eyelet holes (9) of the perforated basket (8) are inclined and have an inclination orientation opposite to the rotation direction of the shaft provided with blades (4).

The capsules to be processed, placed in the loading hopper (3), directly enter in the perforated basket (8) described above through said inlet pipe (6), by virtue of the selector and feeding pipe. Thereby, the capsules come into contact with special shaped fins (5), which are present on the initial part of the blade shaft, to avoid blockage of the pipe (6) as a result of several capsules becoming trapped in the pipe.

In the example shown in FIG. 6a, said inlet pipe (6) preferably has a greater length of the part (33) adjacent to the outlet opening with respect to the opposite one (32). Thereby, the capsules/pods are hindered from exiting the perforated basket (8) too quickly, avoiding having inadequately processed capsules/pods.

By virtue of the rotation of the shaft, said shaped flaps (5) push and force the capsules towards the interior of the perforated basket (8).

After reaching the perforated basket (8) the capsules are torn by the blades (4) described above, for separating the compostable organic contents from the recyclable casing.

Both these components (organic contents and recyclable casing) are projected towards the side surface of the perforated basket (8): the organic part consisting of coffee or another infusion crosses the holes (9), or eyelets, of the basket (8) and, buffered by the inner walls of the containment compartment (7), falls into the first collection container (10) of the organic waste through the lower opening (15) placed on the bottom of the compartment (7).

Furthermore, according to the invention, mechanical rotary cleaning means (22) are provided, consisting of one or more vertical knives/scrapers, placed between the inner side surface of the compartment (7) and the outer side surface of the perforated basket (8), and held in position by a bottom ring and by the walls of the compartment on which they are resting. Said rotary means (22) are manually operable by a handle (23), or in a motorized manner.

By rotating the handle (23) the rotary means (22) and the scraper knives are set in rotation, also by just a few degrees, rotating, guided by the bottom ring, they clean the inner wall of the containment compartment (7) and the outer wall of the perforated basket (8) together with the perforated bottom thereof, from the separated organic powders; advantageously, this contrivance allows keeping the useful space clean, which would otherwise be gradually obstructed by the organic powders, which are often damp, preventing the organic residue from exiting from within the separation compartment.

The prolonged effect of this obstruction would cause the organic residue to come out along with the recyclable casing, eventually reaching a blocking condition the system.

The torn parts of the recyclable casing come out of the outlet (U1, U2, U3) placed on the upper part of the containment compartment (7). The movement of the blades (4) generates a turbulence capable of favoring both the separation between the organic part and the recyclable part, and of determining an upward movement of the recyclable fragments, moving them closer towards said outlet opening (U1, U2, U3).

From the experimental tests, the need emerged to clean the walls of the outlet pipe close to the outlet opening (U1, U2, U3), avoiding obstructions due to accumulations of damp organic residue powder, which would tend to reduce the outlet space thus delaying the outlet of the casing, eventually causing an undesired blockage of the apparatus

FIG. 6a shows a plunger cleaning system (20) with a return spring for cleaning the walls of the outlet pipe of the casings close to the outlet window (U1, U2, U3).

The width of the outlet opening is inversely proportionate to the stay time of the capsules inside the perforated cylinder: the greater the opening (U1, U2, U3), the less the stay time inside the cylinder.

Correspondingly, a smaller opening of the outlet section of the recyclable casings, which results in a longer stay time thereof, allows improved separation between said casings and the organic part, however, the extended stay time in the perforated cylinder is likely to cause the formation of excessively small debris, such as to cross the holes or eyelets (9) of the perforated basket (8), contaminating the organic residue.

Vice versa, a larger opening of the outlet section of the recyclable casings corresponding to a shorter stay time inside the cylinder, will allow obtaining a less effective separation between said casings and the organic residue, while however allowing reduced contamination of the organic waste by fragments of casings slipped through the eyelets (9).

Similarly, it is possible to increase the stay time of the capsules inside the separation compartment using a perforated basket (8) with a greater height and/or greater diameter; in this way, also by using a very wide outlet section of the casings, the stay time of the capsules inside the perforated basket would still be sufficient to ensure adequate separation between organic waste and recyclable casing, as well as reduced contamination of said organic waste retrieved from the casings.

A further particular feature of the present invention consists of the holes or eyelets (9), which can be self-cleaning: in fact, even if they were obstructed by the organic residue from the processed capsules, the knock of the casings and the thrust due to the centrifugal force of the organic material as a result of the rotation given by the blade shaft (4), allows removing the momentary blockages. The fact that the organic contents can momentarily obstruct the holes (9) of the basket (8) does not favor the outlet of the fragments of casing, which are inevitably formed during the processing. Being more volatile, almost all of them will be expelled from the outlet window (U1, U2, U3).

According to the invention, such an apparatus is placeable inside a domestic environment, such as a kitchen, for example, or is installable directly inside larger coffee distributors (obviously with capsules or pods), such as those installed in offices, in companies, restaurants, stations, airports and generally where there are espresso coffee machines with capsules or pods (such as for example on board trains, planes, cruise ships, etc.).

Another possibility is to install the apparatus, which is described separately, normally inside a box especially made for containing all the parts forming the invention and provided with a load-bearing structure thereof, designed to receive the empty capsules to be separated from the outside.

It is interesting to note that, according to the present invention, the arrangement and configuration of the resulting containers can be studied according to the installation environment, simply by conveniently arranging the outlet pipe of the remains of the capsules; in this sense, it is possible to provide an apparatus with substantially overlapping or alternatively adjacent containers.

It is then possible to provide the apparatus with further means for facilitating various operations, such as for example:
One or more mirrors (16) for viewing the capsules inside the machine;
An excess liquid collection box (17) placed beneath the capsule loading compartment (3) the function of which is to collect any spillages of liquid from the empty capsules positioned in the loading compartment;
A loading hopper (18) useful for automating the loading of the empty capsules in the compartment, especially for very large machines;
A capsule counting photocell (19) the function of which is to count the capsules to be processed.

According to the present invention, the control electronics can also include a telemetry system, which allows the invention to communicate, for example by means of a GSM network, with a centralized remote control infrastructure, for viewing online the apparatus data related to processing, alarms, etc.

1. A mechanical system for separating the recyclable casing of the capsules and/or pods used from the compostable organic material contained in said casing, the mechanical system comprising an apparatus including, in combination:
a load-bearing structure, means for loading the capsules and/or pods used,
a motorized separation unit comprising a containment compartment containing a perforated basket,
means for storing and collecting the resulting products,
an electronic and electric control part for managing the operation of the apparatus;
a motorized selector unit provided with a selector wheel with shaped flights;
mechanical means arranged inside said perforated basket for processing the capsules and/or pods, which are adapted to break the casing thereof to separate the organic contents from the casing, collecting the compostable organic contents and the recyclable casings in a first and in a second collection container, respectively, which are different from each other and connected to the containment compartment which can be emptied into the normal containers used for sorting waste;
a feeding opening for feeding said used capsules and/or pods, placed in the upper part of the containment compartment for feeding the capsules and/or pods from the top directly into the perforated basket;
means for conveying the compostable organic material, which has been separated from the rest of the processed capsules and/or pods, from the containment compartment to said first collection container;
means for conveying the remains of the recyclable casings of the processed capsules and/or pods, which have been separated from the organic materials, from the containment compartment to a second collection container;
said mechanical system being provided with manually-operated or motor-driven mechanical rotary cleaning means, adapted to scrape, from the outer walls and from the outer bottom of the perforated basket, as well as from the inner walls and from the inner bottom of the containment compartment, any incrustations of organic material from within the capsules and/or pods, to avoid obstructions, which would block said apparatus;
and wherein:
said motorized selector unit is placed at the top of the containment compartment containing the perforated basket and substantially consists of a wheel provided with special shaped “flights” configured to take a single capsule and/or pod for each seat and direct the single capsule and/or pod towards said feeding opening;
said mechanical means for moving and tearing the capsules consist of an impeller comprising a shaft and blades, which are operable by means of an electric motor capable of being started automatically or manually;
said impeller shaft is provided with at least one shaped fin which is integral with the blade shaft and configured to guide the entry of the capsules into the perforated basket;
at least one outlet opening is present in the upper part of said containment compartment connected to said second container for collecting and storing the casings of the capsules and/or pods handled by said conveying means.

2. The system according to claim 1, wherein said impeller has a lower blade having a geometry and size such as to cut/tear the casing of each capsule and/or pod, as well as to impose a rotary movement and the upward displacement of the torn casings generating the centrifugal force needed to obtain the mechanical separation of the organic material from the rest of the pod and the simultaneous exit of said organic material from the perforated basket, through a plurality of self-cleaning eyelets or holes specifically arranged at least on the side surface of the basket.

3. The system according to claim 2, wherein the flow rate of the air crossing the outlet placed on the upper part of the processing compartment is adjustable by means of a lower end plate of a special plunger provided with a return spring; wherein the change in the flow rate of said outlet causes a consequent change in the stay time of the casings in the perforated basket, allowing an adjustment of the final separation level between compostable organic residue and recyclable casings.

4. The system according to claim 3, wherein the blades are configured to generate a turbulence to suck in and convey upwards only the empty casings.

5. The system according to claim 4, wherein the flaps of the rotation shaft are inclined and protruding, to avoid the capsules from becoming trapped in the feeding pipe thereof.

6. The system according to claim 2, wherein the inner surface of the perforated walls of the processing compartment of the capsules or pods is provided with raised elements or cavities to prevent the capsules and/or pods from remaining coupled to the blades of the impeller and rotating therewith without tearing.

7. The system according to claim 1, wherein the holes present in the perforated basket consist of eyelets, which are inclined in the opposite direction to the rotation direction of the blades of the impeller, to ensure that the large and small parts of the casing, rotating from the bottom upwards, never meet the entirety of the eyelet opening and thus do not cross the eyelet, mixing with the organic material in an undesired manner.

8. The system according to claim 1, wherein the work cycle is managed manually by the user or automatically under the control of an electronic board, which, by means of convenient sensors positioned in strategic places, keeps the apparatus safe and verifies the presence of capsules and/or pods to be processed for activating the device when necessary.

9. The system according to claim 8, further comprising:
a general ON/OFF switch;
a processing cycle start switch;
a handle for operating the rotary cleaning means.

10. The system according to claim 9, further comprising warning lights to signal the ON state of the invention, the presence of capsules/pods to be processed, the end of processing, etc.

11. The system according to claim 1, further comprising one or more of the following elements:
A mirror for displaying the capsules inside the machine;
An excess liquid box placed beneath the loading compartment for loading the capsules the function of which is to collect any spillages of liquid from the empty capsules positioned in the loading compartment;
A loading hopper useful for automating the loading of the empty capsules in the feeding pipe;
A capsule counting photocell the function of which is to count the capsules to be handled and detect the obstruction of the feeding pipe.

12. The system according to claim 1, wherein the configuration of the containers for the resulting materials is modulable as a function of the outlet pipe of the casings and includes overlapping or adjacent containers.

13. The system according to claim 2, wherein the holes present in the perforated basket consist of eyelets, which are inclined in the opposite direction to the rotation direction of the blades of the impeller, to ensure that the large and small parts of the casing, rotating from the bottom upwards, never meet the entirety of the eyelet opening and thus do not cross the eyelet, mixing with the organic material in an undesired manner.

14. The system according to claim 13, wherein the work cycle is managed manually by the user or automatically under the control of an electronic board, which, by means of convenient sensors positioned in strategic places, keeps the apparatus safe and verifies the presence of capsules and/or pods to be processed for activating the device when necessary.

15. The system according to claim 14, further comprising:
a general ON/OFF switch;
a processing cycle start switch;
a handle for operating the rotary cleaning means.

16. The system according to claim 15, further comprising warning lights to signal the ON state of the invention, the presence of capsules/pods to be processed, the end of processing, etc.

17. The system according to claim 16, further comprising one or more of the following elements:
A mirror for displaying the capsules inside the machine;
An excess liquid box placed beneath the loading compartment for loading the capsules the function of which is to collect any spillages of liquid from the empty capsules positioned in the loading compartment;
A loading hopper useful for automating the loading of the empty capsules in the feeding pipe;
A capsule counting photocell the function of which is to count the capsules to be handled and detect the obstruction of the feeding pipe.

18. The system according to claim 17, wherein the configuration of the containers for the resulting materials is modulable as a function of the outlet pipe of the casings and includes overlapping or adjacent containers.
